(19) United States
(12) Patent Application Publication
(10) Pub. No.: US 2007/0217577 A1
(43) Pub. Date: Sep. 20, 2007

(54) Private civil defense-themed television broadcasting method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/426,231

(22) Filed: Jun. 23, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/420,594, filed on May 26, 2006.

(51) Int. Cl. H04M 11/04

(52) U.S. Cl. 379/37

(57) ABSTRACT

One provides (101) a plurality of private civil defense audiovisual programs, wherein various ones of the plurality of private civil defense audiovisual programs provide private civil defense information regarding both naturally-caused and human-caused civilly-catastrophic events. Taken in the aggregate, this private civil defense information (102) comprises information regarding various elements of a proactive private civil defense posture. One or more dedicated private civil defense-themed television broadcast channels are then employed to transmit (103) these programs.

### RELATED APPLICATIONS

This application comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

RESCUE CONTAINER METHOD AND APPARATUS as filed on May 26, 2006 and having application Ser. No. 11/420,594; the contents of which are fully incorporated herein by this reference.

### TECHNICAL FIELD

This invention relates generally to providing survival-related services.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related actions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swath of a given civil entity. Any number of natural and/or human-caused events can greatly disrupt society's infrastructure and corresponding ability to provide one or more life-sustaining resources such as water, nutrition, shelter, and the like.

Many people believe and trust that their government (local, regional, and/or national) will reliably assist them with respect to predicting civilly-catastrophic events and provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to reliably forecast the impact of a given civilly-catastrophic event or to respond, before or after the fact, to even basic survival needs when a civilly-catastrophic event occurs. To a large extent one may reasonably argue that many modern governments have forsaken their responsibility to design, fund, implement, or even discuss an effective civil defense program capable of protecting large segments of their populations.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, many modern governments typically do little to proactively ensure the bulk survival (let alone the comfort) of their citizens in the face of most civilly-catastrophic events. Governmental authorities often provide insufficient (or late) information regarding civil threats of various kinds. Concerned individuals often find themselves with insufficient information regarding specific threats in this regard, including the existence of the threat, the characterizing nature of the threat, meaningful actions that one can take to better ensure one's own survival in the face of the threat, and so forth.

On the other hand, attempting to take responsible actions to independently obtain such information can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

### BRIEF DESCRIPTION OF THE DRAWINGS

The above needs are at least partially met through provision of the private civil defense-themed television broadcasting method described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a schematic screen shot as configured in accordance with various embodiments of the invention;

FIG. 4 comprises a flow diagram as configured in accordance with various embodiments of the invention; and

FIG. 5 comprises a schematic screen shot as configured in accordance with various embodiments of the invention.

Skilled artisans will appreciate that elements in the figures are illustrated for simplicity and clarity and have not necessarily been drawn to scale. For example, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a plurality of private civil defense audiovisual programs, wherein various ones of the plurality of private civil defense audiovisual programs provide private civil defense information regarding both naturally-caused and human-caused civilly-catastrophic events. Taken in the aggregate, this private civil defense information comprises information regarding various elements of a proactive private civil defense posture. Examples in this regard include, but are not limited to, information regarding characterizing attributes as pertain to various civilly-catastrophic events, general actions that individuals in general can take to better prepare to better their chances of surviving a given civilly-catastrophic event, likelihoods of specific civilly-catastrophic events occurring, and specific recommendations for specific individuals (including but not limited to authorized beneficiaries of consideration-based private civil security subscriptions that provide civilly-catastrophic event-based access to at least one life-sustaining resource).

One or more dedicated private civil defense-themed television broadcast channels are then employed to transmit this plurality of private civil defense audiovisual programs. By one approach, if desired, these teachings can be used in conjunction with transmittable codes that are correlated to corresponding survival information. Such codes can serve to facilitate the conveyance of private survival information to specific viewers such as the aforementioned authorized beneficiaries.

So configured, general program recipients will be able to become generally better informed regarding various civilly-catastrophic threats and to be generally better prepared to more predictably and reliably survive a variety of such threats. In addition, authorized beneficiaries as noted above will be able to reliably and predictably receive specific information regarding recommended actions as correspond to their consideration-based private civil security subscriptions. Accordingly, the individuals comprising the viewing audience can take important steps to bring a considerably improved measure of security into their lives without having to effectively become a full-time survivalist; such individuals can, in short, continue to enjoy their chosen vocations and standard of living knowing that, should a civilly-catastrophic event indeed be visited upon them, they will have had extraordinary access to one or more preparational informational resources that will greatly enhance their survival opportunities.

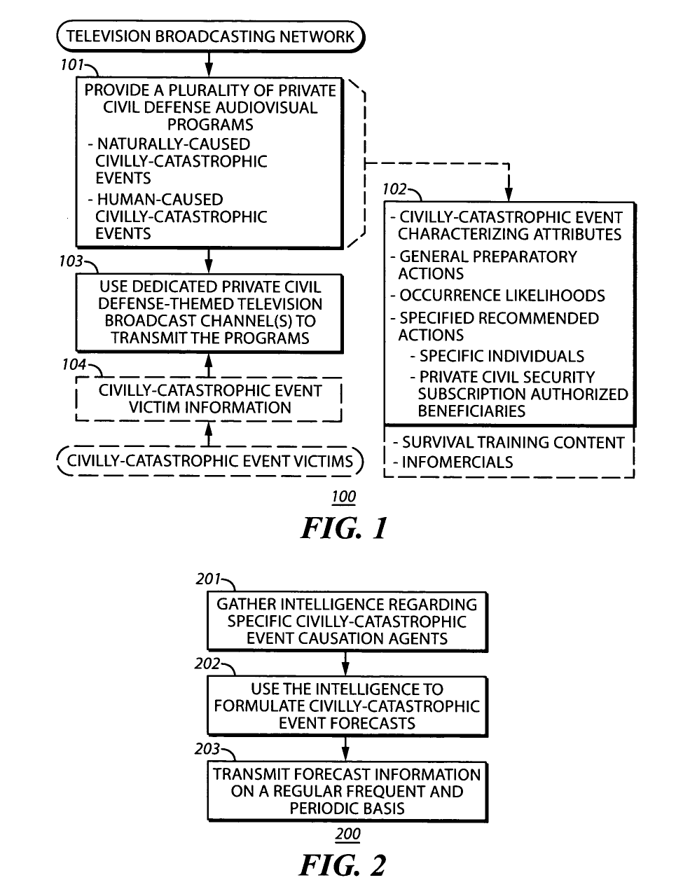

These and other benefits may become clearer upon making a thorough review and study of the following detailed description. Referring now to the drawings, and in particular to FIG. 1, these teachings provide a process 100 to facilitate the provisioning of a television broadcasting network with private civil defense-related content. This process 100 comprises providing 101 a plurality of private civil defense audiovisual programs, wherein various ones of the plurality of private civil defense audiovisual programs provide private civil defense information regarding naturally-caused civilly-catastrophic events as well as human-caused civilly-catastrophic events.

As used herein, “civilly-catastrophic event” will be understood to refer to an event that substantially and materially disrupts a society's local, regional, and/or national infrastructure and ability to provide in ordinary course at least one life-sustaining resource. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well as intentional acts of war, terrorism, madness, or the like. Examples of human-caused disasters capable of such potential scale include, but are not limited to, nuclear-related events (including uncontrolled fission or fusion releases, ionizing radiation exposure, and so forth), acts of war, the release of deadly or otherwise disruptive biological or chemical agents or creations, and so forth.

In the aggregate 102, this private civil defense information can comprise, at least in part, information regarding characterizing attributes regarding various civilly-catastrophic events (such as their causes, their immediate and longer term effects and impact, their relative short term and long term likelihoods of occurring, and ways by which such events may be personally anticipated), general actions that individuals in general can take to better prepare to at least survive given civilly-catastrophic events (such as particular supplies to pre-provision, specific attributes of sheltering or other protective actions that one may take, and particular behaviors to adopt or encourage and/or skills to acquire to better facilitate one's own chances of surviving such an event), likelihoods of specific civilly-catastrophic events occurring (as specified, for example, with respect to various relevant risk criteria such as geography, time, season, political and/or religious affiliation, racial and/or cultural standing or affinity, and so forth), specific recommended actions for specific individuals with respect to a present civilly-catastrophic event scenario (such as, for example, those individuals who reside within a particular denoted geographic area), and so forth.

This private civil defense information 102 can also comprise specific recommended actions for authorized beneficiaries of consideration-based private civil security subscriptions that provide civilly-catastrophic event-based access to at least one life-sustaining resource. The latter can comprise, for example, resources that pertain to hydration, nourishment, shelter, environmentally borne threat abatement (such as protection from chemical, biological, and/or radioactive threats and the like), transportation, and/or rescue services. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights in the at least one life-sustaining resource);

non-transferable rights of access (as may occur when the subscription, by its terms and conditions, prohibits transfer of the right of access to the at least one life-sustaining resource from a first named beneficiary to another);

transferable rights of access (as may occur when the subscription, by its terms and conditions, permits conditional or unconditional transfer of the right of access to the at least one life-sustaining resource from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access the at least one life-sustaining resource); and/or

non-ownership-based rights of access (as may occur when the subscription, by its terms and conditions, establishes the aforementioned right of access via, for example, a lease, rental, or borrowing construct).

There are various ways by which such programs can be provided. By one approach, for example, this step can comprise, at least in part, gathering information regarding past, present, and potential civilly-catastrophic events from various sources (including both public and private sources as desired and available) and using that information to provide the aforementioned plurality of private civil defense audiovisual programs. This step may also comprise, if desired, the use of new original research to develop new information in this regard.

Various kinds of private civil defense audiovisual programs can be employed in this regard. For example, by one approach, these programs can comprise one or more of a natural history program (to present, for example, relevant historical examples), a scientific study (to present, for example, the facts and figures as pertains to the causes, effects, and/or enabling technologies of various kinds of civilly-catastrophic events), and/or a political study as relates to one or more categories, kinds, and/or examples of civilly-catastrophic events. As another example, if desired, these programs can comprise one or more programs that deal instead with preparation and survival information. Illustrative examples in this regard would include, but are not limited to:
a program that identifies particular supplies that are useful to obtain prior to a civilly-catastrophic event to better facilitate surviving that civilly-catastrophic event (where illustrative examples in this regard might include particular foods, consumable liquids, medicines and medical supplies, clothing, airborne threat abatement apparatus, shelter construction materials, vehicles, self-defense equipment, tools (including but not limited to food preparation tools and equipment), communications equipment, power sources, personal hygiene products, lighting equipment, barter medium, pet supplies, and so forth);
a program that identifies particular suppliers of recommended survival supplies;
a program that identifies particular precautions to take to better facilitate surviving a civilly-catastrophic event (ranging, for example, from how to maintain a fresh and current stockpile of supplies and how to fashion a shelter to provide protection from one or more kinds of civilly-catastrophic events to planning one or more evacuation routes and establishing a post-event protocol that group members can employ to locate one another); and
a program that identifies recommended usage of survival-related supplies when surviving a civilly-catastrophic event (including, for example, such topics as a recommended order of usage, rationing criteria and plans, equipment and tool instructions, first aid training, pharmacological strategies, and so forth);
   to note but a few.

Other programs may also be offered in this regard. As one example in this regard, one or more programs that present a fictional representation of a civilly-catastrophic event can be offered. By one approach this programming can primarily serve as an entertainment feature. By another approach, such programming can more primarily serve as a kind of informational and/or training medium with any entertainment value comprising a secondary purpose.

As another example in this regard, such programming can comprise one or more programs that present a simulation of such content as a civilly-catastrophic event. Such simulations can serve as stand-alone programming or can comprise a part of other programming options as have been identified herein. By one approach the simulation can relate instead to civilly-catastrophic event-based viewer-actionable precautionary actions. So configured, the simulation content can serve as an instructional and/or advisory mechanism regarding specific actions that viewers can themselves implement to better prepare themselves to survive a civilly-catastrophic event. By yet another approach the simulation can relate instead to post-civilly-catastrophic event-based viewer actionable survival-enhancing actions. So configured, the simulation content can serve as an instructional and/or advisory mechanism regarding specific actions that viewers can themselves implement to better navigate the challenges that will likely follow the occurrence of a given civilly-catastrophic event.

As noted above, the provided programming can comprise, in part, information regarding likelihoods of specific civilly-catastrophic events occurring. There are various ways to facilitate the provision of such information. As one illustrative example in this regard, and referring momentarily to FIG. 2, one useful process 200 would provide for gathering 201 intelligence regarding specific civilly-catastrophic event causation agents. These can comprise, for example, naturally-caused civilly-catastrophic event agents such as extreme weather events, extreme geologic events, and so forth. These can also comprise, if desired, agents other than naturally-caused civilly-catastrophic event agents. Examples in this regard might include, but are certainly not limited to, prompting or sustaining agents regarding political, religious, ethnic, or other kinds of social unrest.

This process 200 then provides for using 202 the intelligence, at least in part, to formulate civilly-catastrophic event forecasts. Various intelligence factors can of course be applied in this regard. Some relevant examples would include, but are not limited to, information regarding the likely magnitude of impact of a given potential civilly-catastrophic event (with events of greater likely civil magnitude, for example, perhaps more likely garnering a forecast mention notwithstanding a present relatively low likelihood of occurring), existing weather conditions, predicted weather conditions, seasonal-based conditions (as may pertain, for example, to climate, individual and/or crowd behaviors, traffic conditions, supplies and commodities availability, disease vectors and patterns, and so forth), geographic circumstances, a time of day, population size, and so forth.

This process 200 then provides for using 203 the aforementioned dedicated private civil defense-themed television broadcast channel (or channels) to transmit information regarding these civilly-catastrophic event forecasts. Such broadcasts can be offered in a relatively unsynchronized and/or irregular manner or, if desired, can be transmitted on a regular relatively frequent and periodic basis. As one illustrative example of the latter, forecast information regarding local forecasted threats could be provided every fifteen minutes. Such forecasts could be provided during transitions from one program to another, as an interruption during a given program, or as co-provided content during the presentation of another program.

By one approach, such intelligence is used to formulate civilly-catastrophic event forecasts that are local to a particular limited geographic area (such as a given city (or portion of a given city), county, state, or the like). In such a case, the aforementioned transmission step can comprise broadcasting civilly-catastrophic event forecasts as are localized by content to a particular limited geographic area in a limited manner that tends to include viewers who are located within that limited geographic area while tending to exclude viewers who are located outside that particular geographic area. So configured, viewers would tend to receive threat forecast information of particular personal relevance while not necessarily being similarly exposed to less relevant information.

Referring again to FIG. 1, as noted above, the provided programming can comprise, if desired, programming that represents specific recommended actions for specific individual viewers. This can comprise, for example, information that is specifically targeted for individuals who comprise persons who are presently located within a particular geographic area (such as a metropolitan area or some portion thereof). As one example in this regard, the information may comprise evacuation routing recommendations and the individuals may comprise persons who are within the area to which the evacuation routing instructions particularly apply.

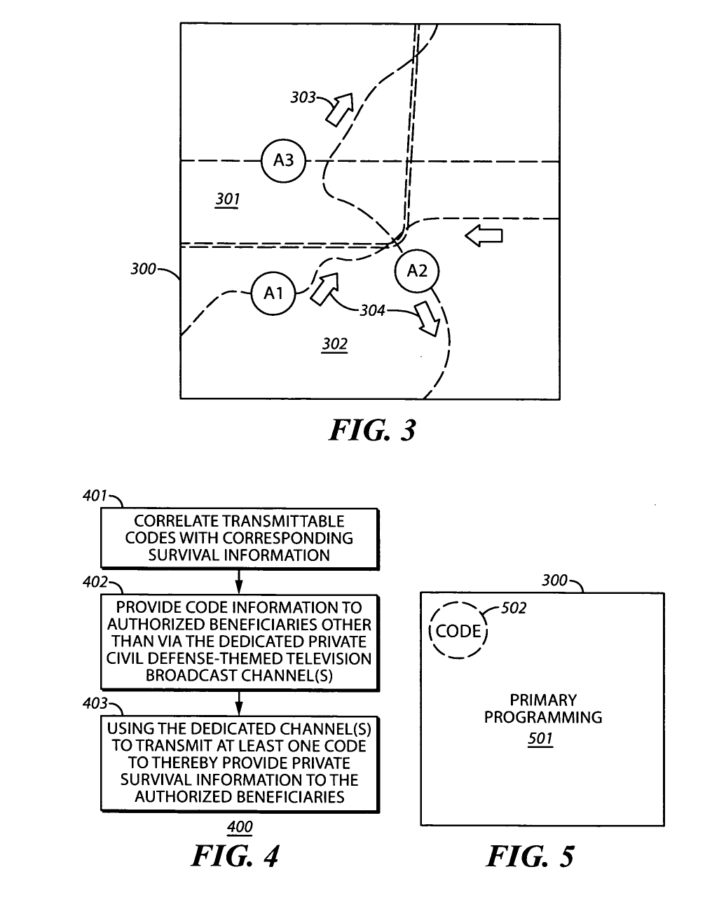

To illustrate, and referring momentarily to FIG. 3, a given displayed transmission 300 may present a given geographic area having various existing thoroughfares. Illustrative thoroughfares shown here include the roads denoted by road names A1, A2, and A3. In this example, the geographic area shown has been subdivided into a first area 301 and a second area 302 as demarked by the double phantom line. So configured, in this illustrative example, individuals in the first area 301 are instructed to use an evacuation route denoted by a corresponding arrow 303. In this example, this evacuation route heads generally north. Individuals in the second area 302, however, receive different instructions. In this second area 302 the evacuation route arrows 304 lead these individuals ultimately on a southern route. Such differing instructions can reflect any of a variety of applied criteria, including but not limited to present or predicted congestion, wind patterns, destination proximity, and so forth.

Those skilled in the art will understand and appreciate that such evacuation instructions may be provided during a time of immediate need but may also be provided prior to the need actually arising. For example, such information can be provided from time to time in order to keep viewers apprised of what evacuation route they could or should use in the event a civilly-catastrophic event (whether forecast or not) occurs. This can be particularly important, for example, in event scenarios where television broadcasting and/or reception are partially or fully disabled during the actual time of need.

As another example, this target content may comprise information for persons who have a particular cultural (such as, but not limited to, political, religious, ethnic, racial, or the like) affiliation, economic status, or the like. Other bases and criteria for targeting particular programming for particular viewers may of course be considered and applied in accordance with the needs, requirements, and/or options presented by a given application setting.

As noted earlier, at least some of the provided programming content can comprise survival training content. By one approach, if desired, this survival training content can be specifically formed, delivered, and/or intended for authorized beneficiaries of consideration-based private civil security subscriptions as described above. Viewed generally, for example, such survival training content could serve to facilitate an ability of the authorized beneficiaries to better comply with the terms and conditions of their subscriptions.

This could comprise, for example, receiving training that will enable such viewers to better receive the benefits of services as are provided pursuant to such subscriptions. To illustrate, such survival training content could comprise information regarding the contents, storage, and usage of survival-related supplies as are provided to the authorized beneficiaries pursuant to their subscriptions, locating, boarding, and traveling in pre-arranged subscription-based transport, how to cooperate with rescue personnel to aid with effecting one's own rescue and/or extraction, shelter facilities and recommended behaviors, and so forth.

If desired, such survival training content could serve to facilitate an ability of subscribers to such subscriptions to receive reduced-consideration private civil security subscriptions. As described in the aforementioned PERSONAL PROFILE-BASED PRIVATE CIVIL SECURITY SUBSCRIPTION METHOD patent application as filed on Apr. 11, 2006 and having application Ser. No. 11/279,333, documented or certified training can serve as a basis for reduced-cost subscriptions. Such a reduction is based upon the primary notion that a well-trained authorized beneficiary will be easier to handle and care for during a time of need. Therefore, at least some of the provided programming can comprise training materials that can be used by authorized beneficiaries when working to achieve a requisite quantity of instruction in this regard.

As noted above, the provided programming can comprise, in part, information regarding recommended survival materials and activities. Somewhat in this regard, if desired, this process 100 will further optionally accommodate including corresponding relevant infomercials in such programming. Illustrative examples in this regard would include (but are not limited to) infomercials regarding civilly-catastrophic event-related survival supplies, civilly-catastrophic event-related survival apparatus, civilly-catastrophic event-related survival plans, and/or civilly-catastrophic event-related survival services (including, for example, virtual tours of private civil defense shelter facilities, explanation of emergency private transport and/or rescue services, and so forth), to note but a few. A somewhat related programming concept would be a product/service rating program where survival-related products and/or services are explained, tested, vetted, and ranked or rated with respect to their efficacy, use, pluses, minuses, and relative value.

If desired, this process 100 will also optionally accommodate receiving 104 civilly-catastrophic event victim information from such victims and then using 103 the above mentioned dedicated private civil defense-themed television broadcast channel(s) to transmit such civilly-catastrophic event victim information. Such transmissions could, if desired, be presented in tandem with other private civil defense audiovisual programs as are broadcast by the television broadcasting network. Such information could comprise, for example, information regarding victim identities, their present state of well-being, present (or future) contact information, and so forth and might serve, for example, to aid in facilitating communications amongst a given group of authorized beneficiaries of the aforementioned subscriptions.

Such network facilities can also be used, if desired, to facilitate coded communications with, for example, authorized beneficiaries of such subscriptions. To illustrate, and referring now to FIG. 4, a corresponding process 400 can provide for correlating 401 transmittable codes with corresponding survival information. Such transmittable codes may comprise visual codes (such as alphanumeric sequences, particular color schemes or other patterns, graphic images (such as icons of various objects or geometric shapes), bar codes, and so forth), audible codes (such as articulated alphanumeric sequences, one or more tones, specific melodies, and so forth), and/or codes that are not discernable by any ordinary human senses (such as specific modulation patterns that, when displayed on a television screen, are discernable and interpretable by corresponding equipment that, in turn, can communicate the received results to the authorized beneficiary).

The aforementioned corresponding survival information as is correlated with such transmittable codes can comprise any useful information in this regard including, but not limited to, instructions to act in a specific manner or to do something in particular. As one example, a first code might serve to notify a particular pre-identified group of authorized beneficiaries of a heightened likelihood regarding a need to evacuate. As another example, a second code might serve to notify a particular pre-identified group of authorized beneficiaries of the initiation of a training exercise.

This process 400 then provides 402 such information to the authorized beneficiaries other than via the dedicated private civil defense-themed television broadcast channel(s). For example, such information can be provided via delivery of hardcopy to the intended recipients, via facsimile transmission, via email, as downloadable content at a secure password protected Web site, and so forth. The purpose of this step is to provide the authorized beneficiaries with the information that they will need to decode such codes when and if these codes are actually transmitted.

This process 400 then provides for using 403 the dedicated private civil defense-themed television broadcast channel to transmit at least one of the transmittable codes to thereby provide private survival information to the authorized beneficiaries. With reference to FIG. 5, if desired, by one approach this can comprise transmitting such a code 502 while also transmitting one of the aforementioned private civil defense audiovisual programs 501 such that both items are simultaneously displayed on the television display 300. In this illustrative example the code 502 appears in the upper left-hand corner. Other positions and orientations are possible as well, of course. If desired, the relative position of such a code can itself also comprise a part of the coded content. As one example in this regard, presentation of a code on the left side of the screen can signify a test transmission of the code whereas presentation of a code on the right side of the screen can signify a non-test conveyance of information. It would of course be possible to present more than one of these codes at the same time in order to convey a plurality of corresponding messages (potentially to differing corresponding audiences).

It will be appreciated that these teachings provide for a highly flexible yet powerfully effective way by which a modern citizen can receive information that will greatly improve their likelihood of surviving a civilly-catastrophic event. These teachings are sufficiently flexible so as to accommodate the needs and desires of a wide-ranging set of potential beneficiaries. The viewers of such programming will of course increase their theoretical and practical knowledge of the aforementioned topics. It might also be expected, however, that the existence of such a network and the nature of its content will help to more generally increase both a relative level of dialogue and awareness regarding these topics in society at large as well as the practical ability of individuals and organizations to better survive civilly-catastrophic events when and as such events occur.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, the aforementioned programs can further comprise a program that presents instructions regarding specific actions that a viewer can take with respect to a given civilly-catastrophic event (such as, for example, an imminent civilly-catastrophic event). To illustrate, this can comprise a program that presents instructions regarding formulation of an emergency shelter that the viewer can form using substantially only commonly available household items (such as, but not limited to, mattresses, specific items of furniture, expandable caulking, adhesive tape, bathtubs, and so forth) to thereby facilitate near-term preparation of such a shelter. Such information, provided at a time of need (or just prior thereto) would facilitate allowing viewers to better protect themselves from a given civilly-catastrophic event.

I claim:

1. A method comprising:
providing a plurality of private civil defense audiovisual programs, wherein various ones of the plurality of private civil defense audiovisual programs provide private civil defense information regarding:
naturally-caused civilly-catastrophic events; and
human-caused civilly-catastrophic events;
and wherein the private civil defense information in aggregation comprises, at least in part, information regarding:
characterizing attributes regarding the civilly-catastrophic events;
general actions that individuals in general can take to better prepare to at least survive given civilly-catastrophic events;
likelihoods of specific civilly-catastrophic events occurring;
specific recommended actions for specific individuals with respect to a present civilly-catastrophic event scenario;
specific recommended actions for authorized beneficiaries of consideration-based private civil security subscriptions that provide civilly-catastrophic event-based access to at least one life-sustaining resource;
using at least one dedicated private civil defense-themed television broadcast channel to transmit the plurality of private civil defense audiovisual programs, such that general program recipients are able to:
become generally informed regarding various civilly-catastrophic threats;
become generally better prepared to more predictably and reliably survive various civilly-catastrophic threats;
and such that the authorized beneficiaries are able to reliably and predictably receive specific information regarding recommended actions as correspond to their consideration-based private civil security subscriptions.

2. The method of claim 1 wherein providing a plurality of private civil defense audiovisual programs comprises providing at least one of:
a natural history program regarding a civilly-catastrophic event;
a scientific study regarding a civilly-catastrophic event;
a political study regarding a civilly-catastrophic event.

3. The method of claim 1 wherein providing a plurality of private civil defense audiovisual programs comprises providing at least one of:
a program that identifies particular supplies that are useful to obtain prior to a civilly-catastrophic event to better facilitate surviving a civilly-catastrophic event;
a program that identifies particular suppliers of recommended survival supplies;
a program that identifies particular precautions to take to better facilitate surviving a civilly-catastrophic event;
a program that identifies recommended usage of survival-related supplies when surviving a civilly-catastrophic event.

4. The method of claim 1 wherein providing a plurality of private civil defense audiovisual programs comprises providing a program presenting a fictional representation of a civilly-catastrophic event.

5. The method of claim 1 wherein providing a plurality of private civil defense audiovisual programs comprises providing a program presenting a simulation of at least one of:
a civilly-catastrophic event;
civilly-catastrophic event-based viewer-actionable precautionary actions;
post-civilly-catastrophic event-based viewer actionable survival-enhancing actions.

6. The method of claim 1 wherein providing a plurality of private civil defense audiovisual programs comprises providing a program presenting evacuation routing recommendations.

7. The method of claim 6 wherein providing a program presenting evacuation routing recommendations comprises providing a program presenting evacuation routing recommendations on a regular periodic basis.

8. The method of claim 7 wherein providing a program presenting evacuation routing recommendations on a regular periodic basis comprises providing a program presenting evacuation routing recommendations on a regular periodic basis notwithstanding a present relatively low likelihood of a civilly-catastrophic event-necessitated evacuation being considered necessary.

9. The method of claim 1 wherein the information regarding specific recommended actions for specific individuals with respect to a present civilly-catastrophic event scenario comprises, at least in part, information specifically targeted for individuals who comprise at least one of:
individuals within a particular geographic area;
individuals of a particular cultural affiliation;
individuals of a particular economic affiliation.

10. The method of claim 1 further comprising:
using the at least one dedicated private civil defense-themed television broadcast channel to transmit infomercials regarding at least one of:
civilly-catastrophic event-related survival supplies;
civilly-catastrophic event-related survival apparatus;
civilly-catastrophic event-related survival plans;
civilly-catastrophic event-related survival services.

11. The method of claim 1 further comprising:
gathering intelligence regarding specific civilly-catastrophic event causation agents;
using the intelligence, at least in part, to formulate civilly-catastrophic event forecasts;
using the at least one dedicated private civil defense-themed television broadcast channel to transmit information regarding the civilly-catastrophic event forecasts.

12. The method of claim 11 wherein using the at least one dedicated private civil defense-themed television broadcast channel to transmit information regarding the civilly-catastrophic event forecasts comprises transmitting the information regarding the civilly-catastrophic event forecasts on a regular relatively frequent and periodic basis.

13. The method of claim 11 wherein:
using the intelligence, at least in part, to formulate civilly-catastrophic event forecasts comprises using the intelligence to formulate civilly-catastrophic event forecasts that are local to a particular limited geographic area;
using the at least one dedicated private civil defense-themed television broadcast channel to transmit information regarding the civilly-catastrophic event forecasts comprises broadcasting the civilly-catastrophic event forecasts that are local to a particular limited geographic area in a limited manner that tends to include viewers within the particular limited geographic area and exclude viewers outside the particular limited geographic area.

14. The method of claim 11 wherein gathering intelligence regarding specific civilly-catastrophic event causation agents comprises gathering intelligence regarding specific civilly-catastrophic event causation agents other than naturally-caused civilly-catastrophic event agents.

15. The method of claim 11 wherein using the intelligence, at least in part, to formulate civilly-catastrophic event forecasts comprises, at least in part, using intelligence regarding at least one of the following:
a likely magnitude of impact of a given potential civilly-catastrophic event;
existing weather conditions;
predicted weather conditions;
seasonal-based conditions;
geographic circumstances;
a time of day;
population size.

16. The method of claim 1 further comprising:
providing survival training content.

17. The method of claim 16 wherein providing survival training content comprises providing survival training content specifically designed for the authorized beneficiaries of consideration-based private civil security subscriptions that provide civilly-catastrophic event-based access to at least one life-sustaining resource to facilitate an ability of the authorized beneficiaries to better comply with terms and conditions of the consideration-based private civil security subscriptions.

18. The method of claim 16 wherein providing survival training content comprises providing survival training content specifically designed for the authorized beneficiaries of consideration-based private civil security subscriptions that provide civilly-catastrophic event-based access to at least one life-sustaining resource to facilitate an ability of the authorized beneficiaries to better receive benefits of services as are provided pursuant to the consideration-based private civil security subscriptions.

19. The method of claim 1 further comprising:
providing survival training content specifically designed for the authorized beneficiaries of consideration-based private civil security subscriptions that provide civilly-catastrophic event-based access to at least one life-sustaining resource to facilitate an ability of the authorized beneficiaries to receive reduced-consideration private civil security subscriptions.

20. The method of claim 1 wherein providing a plurality of private civil defense audiovisual programs comprises, at least in part, gathering information regarding past, present, and potential civilly-catastrophic events and using the information regarding past, present, and potential civilly-catastrophic events to provide the plurality of private civil defense audiovisual programs.

21. The method of claim 1 further comprising:
correlating transmittable codes with corresponding survival information;
providing information regarding the transmittable codes to the authorized beneficiaries of the consideration-based private civil security subscriptions other than via the dedicated private civil defense-themed television broadcast channel;
using the dedicated private civil defense-themed television broadcast channel to transmit at least one of the transmittable codes to thereby provide private survival information to the authorized beneficiaries.

22. The method of claim 21 wherein the transmittable codes comprise visual codes.

23. The method of claim 21 wherein the transmittable codes comprise audible codes.

24. The method of claim 21 wherein the transmittable codes are not discernable by any ordinary human sense.

25. The method of claim 21 wherein using the dedicated private civil defense-themed television broadcast channel to transmit at least one of the transmittable codes to thereby provide private survival information to the authorized beneficiaries comprises transmitting the transmittable codes while simultaneously also transmitting one of the private civil defense audiovisual programs on the same dedicated private civil defense-themed television broadcast channel.

26. The method of claim 1 further comprising:
using at least one dedicated private civil defense-themed television broadcast channel to transmit civilly-catastrophic event victim information.

27. The method of claim 26 wherein using at least one dedicated private civil defense-themed television broadcast channel to transmit civilly-catastrophic event victim information comprising presenting the civilly-catastrophic event victim information in tandem with one of the plurality of private civil defense audiovisual programs.

28. The method of claim 26 wherein using at least one dedicated private civil defense-themed television broadcast channel to transmit civilly-catastrophic event victim information comprises receiving the civilly-catastrophic event victim information from civilly-catastrophic event victims.

29. The method of claim 1 wherein providing a plurality of private civil defense audiovisual programs comprises providing a program presenting instructions regarding specific actions that a viewer can take in a relatively immediate timeframe in order to better protect themselves from a given civilly-catastrophic event.

30. The method of claim 29 wherein providing a program presenting instructions regarding specific actions that a viewer can take comprises providing a program presenting instructions regarding formulation of an emergency shelter that the viewer can form using substantially only commonly available household items, to thereby facilitate preparation of such a shelter to thereby facilitate protecting the viewer from a given civilly-catastrophic event.
